(19) United States
(12) Patent Application Publication
(10) Pub. No.: US 2006/0074695 A1
(43) Pub. Date: Apr. 6, 2006

(54) System and method for reporting and delivering sales and market research data

(75) Inventors: Seth Houston, Lansale, PA (US); Fred Figg, Schwenksville, PA (US); Domenic J. Bonanni, Drexel Hill, PA (US)

Correspondence Address: BAKER & BOTTS, 30 ROCKEFELLER PLAZA, NEW YORK, NY, 10112, US

(73) Assignee: IMS Health Incorporated, Plymouth Meeting, PA (US)

(21) Appl. No.: 10/509,442

(22) PCT Filed: Apr. 3, 2003
(86) PCT No.: PCT/US03/10381

§ 371 Date: Sep. 26, 2005

Related U.S. Application Data
(60) Provisional application No. 60/369,709, filed on Apr. 3, 2002.
(60) Provisional application No. 60/370,771, filed on Apr. 5, 2002.

(51) Int. Cl. G06Q 99/00; G07G 1/00

(52) U.S. Cl. 705/1; 705/10

(57) ABSTRACT

A system and method for accessing pharmaceutical data is described The method includes receiving a username and a password from a web page, and identifying an account having the username and the password associated therewith. The method further includes reading a service level associated with the identified account, determining at least one question that is authorized to be presented to the web page based on the service level associated with the account, and populating a list control element of the web page with the at least one question.

### CROSS-REFERENCE TO RELATED APPLICATIONS

This application is based on U.S. provisional patent application Ser. No. 60/370,771, filed Apr. 5, 2002, and U.S. provisional patent application Ser. No. 60/369,709, filed Apr. 3, 2002, both of which are incorporated herein by reference for all purposes and from which priority is claimed.

### BACKGROUND OF THE INVENTION

1. Technical Field

The present invention relates to the reporting of product sales and market research data, and more particularly, to the reporting of product sales and market research data using a set of natural language questions to query at least one database containing product sales and market research data.

2. Background Art

Manufacturers and distributors of retail, wholesale and mail-order products generally monitor product sales in order to maintain proper inventory and to be able to direct marketing efforts. Monitoring may be accomplished by documenting sales at wholesale distributors, retail outlets and mail-order facilities and transferring this sales data to a central point for evaluation. Sales data is valuable as a business intelligence tool to regularly inform sales professionals about the state of the marketplace.

In particular, each day throughout the pharmaceutical and healthcare industries millions of products are sold worldwide. Product saless are written by doctors and filled at pharmacies; medical devices are sold at doctors offices, hospitals and pharmacies. Individual businesses participating in various aspects of the pharmaceutical and healthcare industries create data pertaining to the goods sold to conform with governmental regulations, to aid in inventory tracking, and to track market share possessed by branded and generic manufacturers.

Other industries where sales of product is driven by a perceived need would benefit from such a business intelligence tool, particularly the replacement parts industry. As a prescription is written to address a particular illness or therapy prescribed, particular replacement auto parts are purchased to repair an automible having a particualr make, model and year, as well as the die cast governing the overall fit of the replacement part, sometimes referred to as the “must fit” rule. It is extremely beneficial for inventory and production efforts to be able to track sales of particular parts which demonstrate an abbreviated life span over projections, or to stock fungible inventory, such as fuel filters and the like, while tracking sales of named manufacturer goods over competing generic replacement parts.

Utilizing highly advanced technologies, this raw, disparate data is transformed from millions of pharmaceutical records collected from thousands of sources worldwide into a centralized data repository. The information contained in the centralized data repository is a powerful business intelligence tool that can be used to gain critical information about the state of the industry.

Accordingly, there exists a need for a system and method able to extract crucial information from the raw information contained in a centralized data repository containing industry data and to produce a report which allows an individual sales person to develop a coherent understanding of the raw information.

### SUMMARY OF THE INVENTION

An object of the present invention is to provide system and method for extracting crucial information from raw information related to sales and market research data through the use of at least one easily understandable natural language question.

A further object of the present invention is to provide a customer having a particular service level with at least one natural language question and a customer having another service level with at least one different natural language question.

It is also an object of the present invention to provide a system, method and logic arrangement that supplies a question and answer format and presents the answers to specific business questions asked by the sales or marketing individual over the internet.

Another object of the present invention is to integrate many different audits and therefore providing answers to complex business questions.

Still another object of the present invention is to provide a system that integrates service and support into the product design.

Yet another object of the present invention is a method for providing estimates with confidence intervals for daily sales activity.

Another object of the present invention is a method for providing forecasting for weekly and/or monthly sales activity.

Yet another object of the present invention is to provide a system which is built around an e-business framework so that central customer records, client management and incident management are part of the market research suite of applications.

In order to meet these objectives and others that will become apparent with reference to the disclosure below, in one exemplary embodiment of the present invention, a method is provided for accessing sales and market research data is described. The method includes receiving a username and a password from a web page, and identifying an account having the username and the password associated therewith. The method further includes reading a service level associated with the identified account, determining at least one question that is authorized to be presented to the web page based on the service level associated with the account, and populating a list control element of the web page with the at least one question.

In another exemplary embodiment of the present invention, a system is provided for accessing sales and market research data is described. The data acquisition system includes a processor configured to receive a username and a password from a web page, identify an account having the username and the password associated therewith, read a service level associated with the identified account, determine at least one question that is authorized to be presented to the web page based on the service level associated with the account, and populate a list control element of the web page with the at least one question.

In yet another exemplary embodiment of the present invention, a method for specifying sales and market research data to be accessed as a basis for a report is provided. The method includes selecting one of an at least one question from a first list control element on the web page, wherein the first list control element is the only list control element on the web page. The method further includes selecting at least one parameter from a second list control element on the web page, wherein the second list control element was created on the web page after the first selection of the one of the at least one question from the first list control element, and wherein the second list control element was populated with the at least one parameter after the first selection of the one of the at least one question from the first list control element.

The accompanying drawings, which are incorporated and constitute part of this disclosure, illustrate preferred embodiments of the invention and serve to explain the principles of the invention.

### BRIEF DESCRIPTION OF THE DRAWINGS

FIG. 1 is a block diagram of a system for extracting information pertaining to sales and market research data from many different databases in accordance with an embodiment of the present invention;

FIG. 2 is a flow chart of a customer driven process for requesting data in accordance with the present invention;

FIG. 3 is a flow chart of a process for obtaining data from at least one database in accordance with the process of FIG. 2;

FIG. 4 is a flow chart of a process for determining a customer's service level in accordance with the process of FIG. 3;

FIG. 5 is a flow chart of a process for determining a set of questions a particular customer is entitled to ask in accordance with the process of FIG. 3; and

FIG. 6 is a flow chart of a process for creating a report given a selected, potentially parameterized question in accordance with the present invention.

Throughout the drawings, the same reference numerals and characters, unless otherwise stated, are used to denote like features, elements, components or portions of the illustrated embodiments. Moreover, while the present invention will now be described in detail with reference to the Figs., it is done so in connection with the illustrative embodiments.

### DETAILED DESCRIPTION OF THE PREFERRED EMBODIMENTS

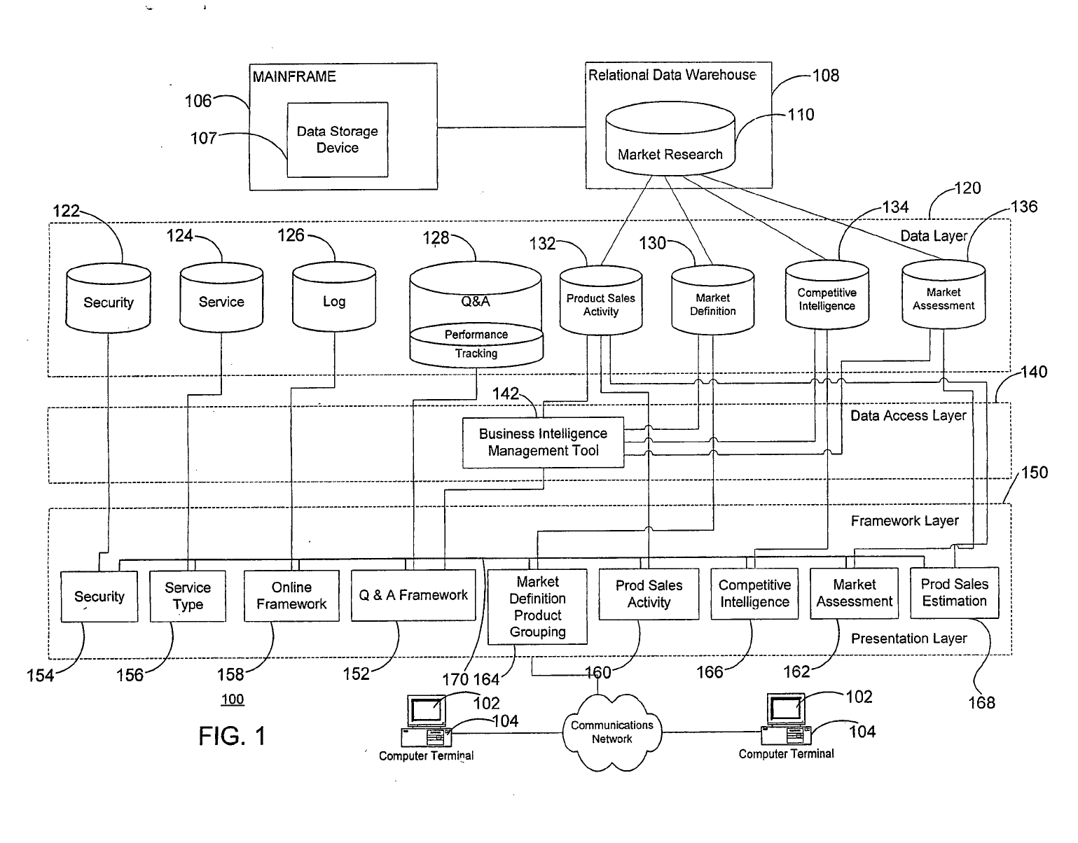

Referring to FIGS. 1-6, an exemplary embodiment of the present invention will be described. FIG. 1 illustrates the logical view of a data analysis system 100. The data analysis system 100 allows a customer to track the performance of individual products or a group of products through a standardized customer interface 102 by relying on retail, wholesale and mail-order sales data. The customer logs onto an internet site using a remote terminal 104 and a username-password combination. Once the user logs onto the Internet site, the user may specify a question, selected from a customized group of questions, which is answered based on audit data stored in a group of databases pertaining to individual products.

Audit data is collected from a variety of sources such as the National Journal Audit, the Direct to Consumer Audit, the Hospital and Doctor Integrated Services Audit, the National Disease and Therapeutic Index Audit, the Chemical Audit, the Daily Rx Audit, the Midas Audit, the Write Decision Audit, and the like, most of which are currently available from IMS Health, Inc., 1499 Post Road, Fairfield, Conn. 06430. The audit data reflects various aspects of individual products, including amount of individual sales for a particular product, number of products purchased by retailers, protuct/size units sold throughout a variety of outlets, amount of prescriptions filled for a drug product, number of products sold, number of times a drug product is prescribed, volume of sales from retail establishments, volume of sales from wholesale establishments, volume of sales from mail-order establishments, and the like. The audit data is stored on a mainframe computer 106 in audit specific mainframe data sets which are stored in a data storage device 107 by a database program running on the mainframe computer 106. The audit specific mainframe data sets are stored in a hierarchical/flat file format. The audit specific mainframe data sets are downloaded to a relational data warehouse 108 at regular intervals.

In a preferred embodiment, the mainframe computer 106 is an International Business Machines (hereinafter “IBM”) mainframe model. In another preferred embodiment, the database program can be CA-IDMS/DB, a database program available from Computer Associates International, One Computer Associates Plaza, Islandia, N.Y. 11749.

The relational data, warehouse 108 is a server running an operating system and a database program. The relational data warehouse 108 stores the audit specific mainframe data sets as relational data in the database program. This database may also be called the market research database 110. The market research database 110 provides market definition data, product sales activity data, prescription activity data, competitive intelligence data, market assessment data, and the like to a data layer 120.

In a preferred embodiment, the database program is an Oracle v9i database, available from Oracle Corporation, 500 Oracle Parkway, Redwood Shores, Calif. 94065. In another preferred embodiment, the operating system is a UNIX operating system.

The data layer 120 provides all information to a data access layer 140 and a framework layer 150. The data layer 120 contains structured query language (hereinafter “SQL”) databases which contain information which is necessary for the data access layer 140 and the framework layer 150 to prepare presentations to be presented to the customer. The data layer 120 includes several different databases, such as a security database 122 containing security information, a service type database 124 containing service type information and market type information, a log database 126 containing log information, a question and answer database 128 containing question and answer information, a market definition database 130 containing market definition information, a product sales activity database 132 containing product sales activity information, a competitive intelligence database 134 containing competitive intelligence information, and a market assessment database 136 containing market assessment information. The data layer 120 provides information to the data access layer 140 and the framework layer 150 in response to SQL queries provided to individual databases by applications running in the data access layer 140 and the framework layer 150.

The data access layer 140 includes a business intelligence management tool 142 that manages queries issued by a question and answer framework application 152 and, upon receipt of data from the data layer 120, formats a report. The business intelligence management tool 142 may receive a query from a question and answer framework application 152. The business intelligence management tool 142 parses the query issued by the question and answer framework application 152 and issues the appropriate SQL queries to one or more appropriate databases 130, 132, 134, 136 in the data layer 120. For example, in a first example if a particular query received by the business intelligence management tool 142 requires product sales activity information, the business intelligence management tool 142 issues an appropriate query to the product sales activity database 132. The SQL databases 130, 132, 134, 136 return data sets to an appropriate application in the framework layer 150. The appropriate application is specified in the SQL query.

In a preferred embodiment, the business intelligence management tool 142 is the business intelligence management tool MicroStrategy 7 available from MicroStrategy, Inc., 1861 International Drive, McLean, Va. 22102. Other tools such as WebIntelligence from Business Objects, Inc. might be used.

The framework layer 150 includes a group of applications which provide an interface between the standard customer interface 102 and the data warehousing systems of the data layer 120. The group of applications include several different applications, such as a security application 154, a service type application 156, an online framework application 158, the question and answer framework application 152, a market definition product grouping application 164, a product sales activity application 160, a competitive intelligence application 166, a market assessment application 162, and a product sales estimation application 168. Each of the group of applications 154, 156, 158, 160, 162, 164, 166, 168 can communicate with each other through a communication link 170. The market definition product grouping application 164, the product sales activity application 160, the competitive intelligence application 166, the market assessment application 162, and the product sales estimation application 168 work with the business intelligence management tool 142 and the SQL databases 130, 132, 134, 136 to create the report. For example, in the first example, the query sent by the business intelligence management tool 142 causes the product sales activity database 132 to generate a data set for the product sales activity application 160, which is then sent to the product sales activity application 160. Once the product sales activity application 160 receives the information, the business intelligence management tool 142 and the product sales activity database 132 generate the report.

The product sales activity application 160 provides metropolitan statistical area level, metropolitan area level, state level, and national level information for prescription activity. The product sales activity application 160 also provides integrated reporting of promotional expenditures, sales figures, current inventory levels, withdrawal from inventory, elements of growth measurements, and on-going product performance tracking. The product sales estimation application 168 provides daily estimates of prescription activity displayed with confidence levels, and provides a weekly and/or monthly forecasting ability to provide estimates for end of week. In an alternate embodiment, the product sales estimation application 168 provides estimates for end of month sales with confidence levels. The confidence levels describe the perceived accuracy of the estimate. The competitive intelligence application 166 provides competitive benchmarking features utilizing data elements from the NPA Plus audit, the Retail and Provider Perspective audit, the Promotional Services audit, the National Disease and Therapeutic Index audit, the DDD Weekly Audit and the Formulary Focus audit, the aforementioned audits are available from IMS Health, Inc., 1499 Post Road, Fairfield, Conn. 06430. The market assessment application 162 allows marketers to assess market potential, understand physician prescribing and diagnosing behavior utilizing data elements relating to a particular relevant market or markets from patient estimates, the Research and Development Focus audit, the Patents International audit, the NPA Plus audit, the Retail and Provider Perspective audit, the Promotional Services audit, the National Disease and Therapeutic Index audit, the Formulary Focus audit, and other data sources.

The report created by the applications 160, 162, 164, 166 and 168, the business intelligence management tool 142 and the SQL databases 130, 132, 134, 136 is displayed in the standard customer interface 102. The online framework application 158 creates the standard customer interface, which is a web page. The standard customer interface includes a login screen and a question and answer screen.

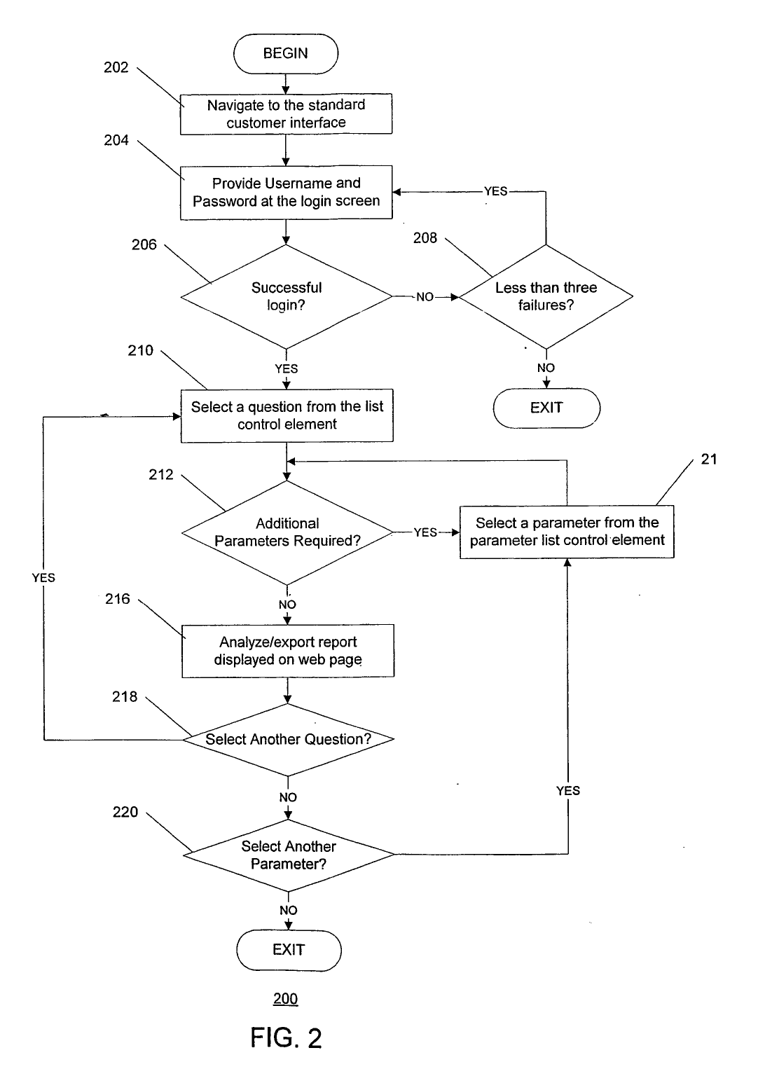

Turning now to FIG. 2, a customer driven data acquisition process 200 is illustrated. In order to gather information from the data analysis system 100, a customer must select a question according to the process 200. The customer begins the process 200 at step 202 by navigating to a login screen of the standard customer interface 102, typically by providing a particular universal resource locator to a web browser. Once the standard customer interface 102 has been provided to the customer's computer screen, the process 200 advances to step 204. At step 204, the customer must provide a username-password combination. The customer provides a username-password combination, clicks on a login button, and the process 200 advances to step 206.

At step 206, the process 200 determines if the username and password combination was recognized by the data analysis system 100. If the username and password combination was recognized, the process 200 advances to step 210. If the username and password combination was not recognized, the process 200 advances to step 208. At step 208, the process 200 determines whether the customer has attempted to log into the system more than three times. If the customer has attempted to log into the system less than three times, the process 200 advances to step 204, and the customer is allowed to attempt to log into the system again. If the customer has attempted to log into the system at least three consecutive times, the process 200 exits.

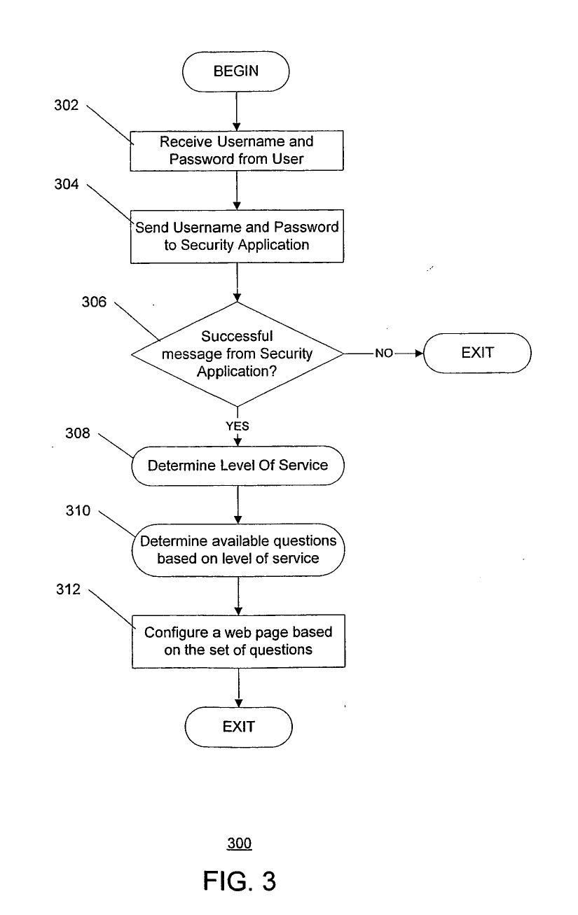

At step 210, the customer selects a questions from a list control element, preferably a drop down menu, containing a set of questions. The set of questions is generated by the data analysis system 100. The process by which the set of questions is generated will be discussed in more detail in relation to FIGS. 3 and 5. Once the customer selects a question from the set of questions, the process 200 advances to step 212.

In a preferred embodiment, the list control element is one of a drop down menu, a list box, a selection menu, a list of hyperlinks in the page itself, and the like.

At step 212, the process 200 determines if additional parameters have to be selected to generate a report for the customer. If no additional parameters have to be selected, the process 200 advances to step 216. If additional parameters have to be selected, the process 200 advances to step 214. At step 214, the customer selects a parameter from a list control element containing a set of parameters. The set of parameters is generated by the data analysis system 100 and may include parameters such as time reference to be analyzed, geographical area to be analyzed, or the like. The process by which the set of parameters is generated will be discussed in more detail in relation to FIGS. 3 and 5. Once the customer selects a parameter from the set of parameters the process advances to step 212.

At step 216, the customer is presented with a report which is generated based on the selected question and potentially parameter or parameters. One of the parameters may be a particular relevant market. The information contained in the report is presented to the customer in a table format and a graph format. The customer can view the report on the screen, can download the report and save it as a particular file type, export the report to a software application, print the report, email the report, or perform other data manipulation processes on the report. Once the customer is finished with the report, the process 200 advances to step 218. At step 218, the customer may select another question of the set of questions. If the customer chooses to select another question, the process 200 advances to step 210. Otherwise the process 200 advances to step 220. At step 220, the customer may select another parameter from the parameter drop down menus. If the customer selects another parameter from the parameter drop down menus, the process advances to step 214. Otherwise, the process 200 exits.

In a preferred embodiment, the information contained in the report is presented to the customer in at least one of a table format, a graph format, a chart format, an audio format and the like. In another preferred embodiment, the consumer can export the report to a spreadsheet, a web browser, or the like.

In order to generate appropriate reports for a customer, the data analysis system 100 must process information supplied by the customer and acquire relevant information from databases 122, 124, 126, 128, 130, 132, 134, 136 in the data layer 120 according to a process 300, shown in FIG. 3. The data analysis system 100 begins the process 300 when it receives a username and a password at step 302. The data analysis system 100 receives the username and password at the online framework application 158. At step 304, the online framework application 158 forwards the username and password to the security application 154. Once the security application 154 receives the username and password, it queries the security database 122, which contains a list of valid username-password combinations. If a match is found in the security database 122, a successful message is passed back to the online framework application 158. If no such match is found, a failed message is passed back to the online framework application 158.

In a preferred embodiment, the security application 154 may be one such as Netegrity SiteMinder, which is available from Netegrity, 52 Second Ave, Waltham, Mass. 02451.

At step 304, the online framework application 158 determines if the login attempt was successful. If the online framework application 158 receives a failed message from the security application 154, the process 300 exits and the online framework application 158 denies further access to the customer who is attempting to log into the system. If the online framework application 158 receives a successful message from the security application 154, the process 300 authenticates the username and advances to a service determination process 308.

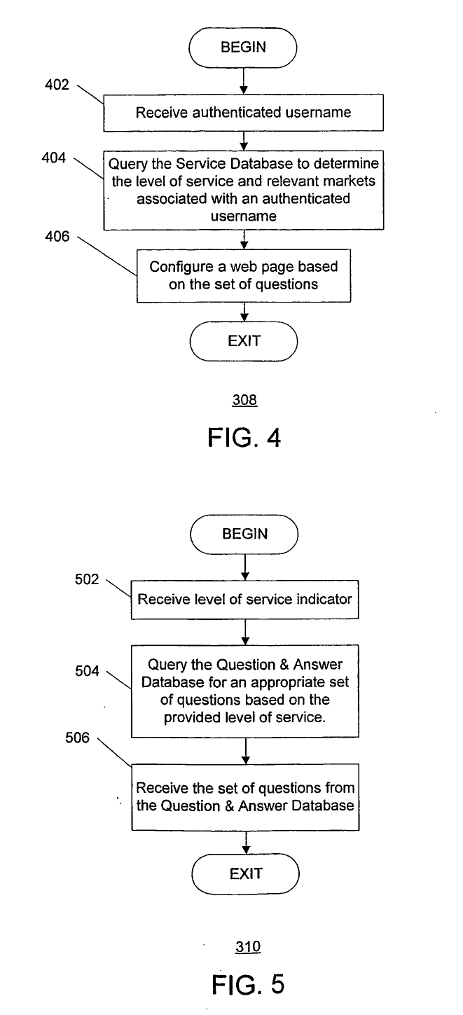

The online framework application 158 determines the level of service and relevant markets available for the account associated with the provided username-password combination during the service determination process 308. The online framework application 158 transmits the authenticated username supplied by the customer to the service type application 156. The service determination process 308 by which the service type application 156 determines the customer's level of service and relevant markets will be discussed in further detail in relation to FIG. 4. The service type application 156 provides the customer's level of service and relevant market indicators to the online framework application 158, and the process 300 advances to a question set generation process 310. The customer defines at least one relevant market upon setup of the customer's account or shortly thereafter. A relevant market definition may contain a list of relevant products.

In a preferred embodiment, the service type application 156 may be one of many customer relationship management (“CRM”) software tools. In another preferred embodiment, the service type application 156 is the Onyx CRM software tool, which is available from Onyx Software, 3180 139th Ave SE, Suite 500, Bellevue, Wash. 98005-4091. In another preferred embodiment, the relevant market definition may contain a geographic area limitation, a temporal limitation and the like.

At the question set generation process 310, the online framework application 158 determines a set of questions and associated parameters which the customer is entitled to ask based on the level of service available for the account associated with the authenticated username. The online framework application 158 transmits the level of service indicator or service level to the question and answer framework application 152. The process by which the question and answer framework application 152 determines the set of questions and associated parameters will be discussed in further detail in relation to FIG. 5. The question and answer framework application 152 provides the set of questions and associated parameters to the online framework application 158, and the process 300 advances to step 312.

At step 312, the online framework application 158 alters the web page being presented to the customer from the login screen to a question and answer screen. The question and answer screen includes a list control element. If the customer clicks on the list control element, a list of questions is displayed. The list of questions includes each of the questions of the set of questions generated by the question and answer framework application 152. After the online framework application 158 alters the web page being displayed, the process 300 exits.

FIG. 4 illustrates the service level determination process 308, which begins at step 402. At step 402 the service type application 156 receives the authenticated username provided by the customer. The service type application 156 then queries the service database 124 to determine the level of service and market types associated with the authenticated username at step 404. The service database 124 responds to this query with a level of service indicator and the market type indicators. Once the service type application 156 receives the service level indicator from the service database 124, the process 308 advances to step 406. At step 406, the service type application 156 transmits the level of service indicator and the relevant market indicators to the online framework application 158 and the service level determination process 308 exits.

FIG. 5 illustrates the question set generation process 310. The question set generation process 310 begins at step 502. At step 502 the question and answer framework application 152 receives a level of service indicator or service level from the online framework application 158. Once the service level is received, the process 310 advances to step 504. At step 504, the question and answer framework application 152 forms an SQL query based on the received service level and transmits this query to the question and answer database 128. In response to this query, the question and answer database 128 provides a set of questions and associated parameters to the question and answer framework application 152. The customer who initially provided the authenticated username is entitled to ask any of these questions and utilize any of the associated parameters.

In a preferred embodiment, the level of service indicator or service level is associated with a set of pointers. Each pointer of the set of pointers points to a question in the questions and answer database 128.

Once the question and answer framework application 152 receives the set of questions from the question and answer database 128, the process 310 advances to step 506. At step 506, the question and answer framework application 152 transmits the set of questions to the online framework application 158 and the question set generation process 310 exits.

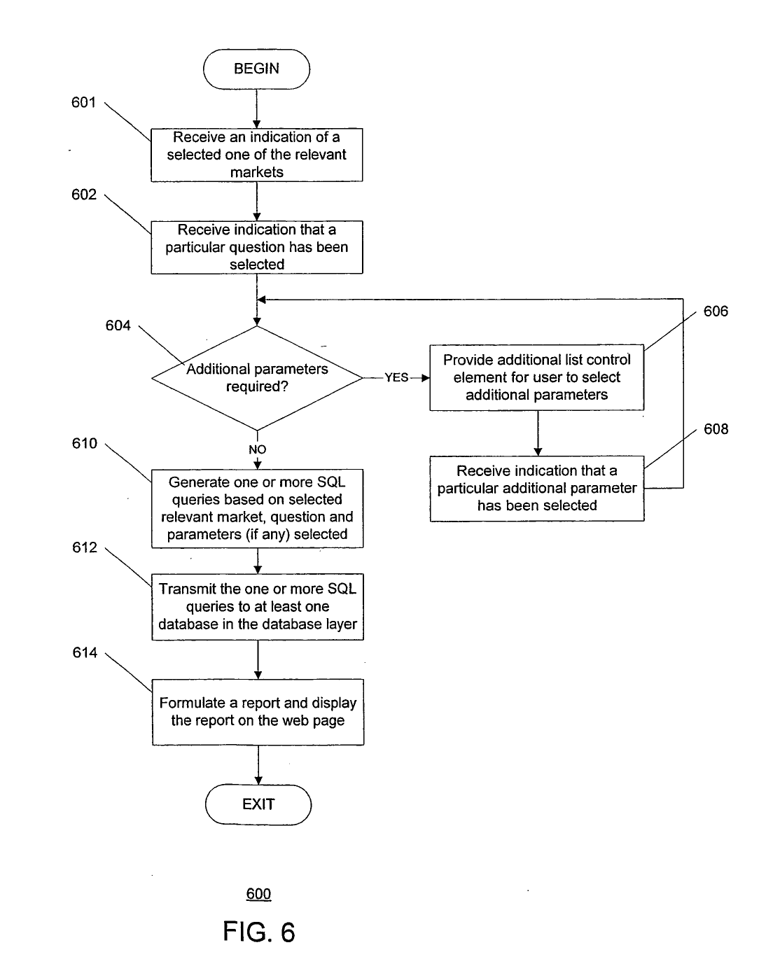

FIG. 6 illustrates a data access and manipulation process 600. The data access and manipulation process 600 begins at step 601 when the business intelligence management tool 142 receives an indication of a selected relevant market. The selected relevant market assists in the acquisition of relevant data by defining a set of relevant drugs, products, geographic area, treatment type, or the like. This step 601 may be automatically skipped, as indicated by the dashed arrow 650, if only one relevant market is associated with the authenticated username or conditionally skipped if a default relevant market is specified.

At step 602 when the business intelligence management tool 142 receives an indication that the customer has selected a particular question from the set of questions presented in the list control element. Once the customer has logged into the data analysis system 100, the customer is presented with a drop down menu in a question portion of the question and answer screen of the web page. The customer may choose any question from the set of questions presented in a drop down menu. After the customer selects a question and clicks on a submit button, a message is sent to the business intelligence management tool 142 informing the data analysis system 100 of the question that has been selected.

At step 604, the business intelligence management tool 142 determines if the question selected by the customer requires additional parameters. If the selected question requires additional parameters, the process 600 advances to step 606. If the selected question does not require additional parameters, the process 600 advances to step 610.

At step 606, the business intelligence management tool 142 provides an additional list control element in the question and answer portion of the web page. The additional list control element is populated with a set of parameters associated with the selected question. Once the additional list control element is provided, the process 600 advances to step 608. At step 608, the business intelligence management tool 142 receives an indication that one of the set of parameters provided in the additional list control element has been selected. Selecting one of the set of parameters allows the customer to customize the question to the customer's unique needs. By selecting certain parameters, the customer may define unique markets or product groupings of particular interest. Once the business intelligence management tool 142 receives the indication that one of the set of parameters has been selected, the process 600 advances to step 604.

The business intelligence management tool 142 translates the selected relevant market, question and parameters (if any) into one or more SQL queries. The business intelligence management tool 142 then issues these one or more SQL queries to the appropriate database 122, 124, 126, 128, 130, 132, 134, 136 in the data layer, which then returns data to the appropriate application 160, 162, 164, 166, 168 in the framework layer 150. Once the SQL queries are issued, the process 600 advances to step 614.

The business intelligence management tool 142 in conjunction with the market definition product grouping application 164, the product sales activity application 160, the competitive intelligence application 166, the market assessment application 162 and the product sales estimation application 168 formulate a report which is provided to an answer portion of the question and answer screen of the standardized customer interface 102. The report may incorporate a graph, a chart, a table, or the like to communicate the appropriate information in the most effective manner. Once the business intelligence management tool 142 in conjunction with the applications 160, 162, 164, 166, 168 have formatted and organized the data collected from the databases 122, 124, 126, 128, 130, 132, 134, 136, the report is displayed to the web page.

The foregoing merely illustrates the principles of the invention. Various modifications and alterations to the described embodiments will be apparent to those skilled in the art in view of the teachings herein. Various markets and product types lend themselves to the principles of the invention, and it will thus be appreciated that although pharmaceutical data is the exemplary market described, alternative markets, such as branded versus non-branded auto parts, would lend themselves readily to such a business intelligence tool. It will thus be appreciated that those skilled in the art will be able to devise numerous techniques which, although not explicitly described herein, embody the principles of the invention and are thus within the spirit and scope of the invention.

We claim:

1. A method for accessing sales data, comprising the steps of:
receiving a username and a password from a web page;
identifying an account having the username and the password associated therewith;
determining a service level associated with the identified account;
determining at least one question that is authorized to be presented to the web page based on the determined service level associated with the account;
populating a list control element of the web page with the at least one question.

2. The method of claim 1, wherein the identification step is performed by a security application.

3. The method of claim 2, wherein the security application searches a database for an account record having the username and the password associated therewith.

4. The method of claim 1, wherein the reading step is performed by a service application.

5. The method of claim 4, wherein the service application searches a database for an account record having the username associated therewith, and reads the service level from the account record.

6. The method of claim 1, wherein the determining step is performed by a question and answer framework application.

7. The method of claim 6, wherein the question and answer framework application searches a database for the at least one questions based upon at least one of a plurality of appropriate service level indicators.

8. The method of claim 6, wherein the at least one of a plurality of appropriate service level indicators is the same as the service level.

9. The method of claim 6, wherein the at least one of a plurality of appropriate service level indicators is different from the service level.

10. The method of claim 1, wherein the at least one question includes at least one parameter.

11. The method of claim 1, further comprising the steps of:
receiving an indication upon a selection of one of the at least one question;
populating a further list control element of the web page with an at least one parameter.

12. The method of claim 1, wherein the list control element is a drop down box.

13. A logic arrangement for accessing sales data, wherein the logic arrangement is adapted for an execution by a processing arrangement to perform the steps comprising of:
receiving a username and a password from a web page;
identifying an account having the username and the password associated therewith;
reading a service level associated with the identified account;
determining at least one question that is authorized to be presented to the web page based on the service level associated with the account;
populating a list control element of the web page with the at least one question.

14. The logic arrangement of claim 13, wherein the identification step is performed by a security application.

15. The logic arrangement of claim 14, wherein the security application searches a database for an account record having the username and the password associated therewith.

16. The logic arrangement of claim 13, wherein the reading step is performed by service application.

17. The logic arrangement of claim 16, wherein the service application searches a database for an account record having the username associated therewith, and reads the service level from the account record.

18. The logic arrangement of claim 13, wherein the determining step is performed by a question and answer framework application.

19. The logic arrangement of claim 18, wherein the question and answer framework application searches a database for the at least one questions based upon at least one of a plurality of appropriate service level indicators.

20. The logic arrangement of claim 18, wherein the at least one of a plurality of appropriate service level indicators is the same as the service level.

21. The logic arrangement of claim 18, wherein the at least one of a plurality of appropriate service level indicators is different from the service level.

22. The logic arrangement of claim 13, wherein the at least one question includes at least one parameter.

23. The logic arrangement of claim 13, further comprising the steps of:
receiving an indication that one of the at least one question has been selected;
populating a further list control element of the web page with an at least one parameter.

24. The logic arrangement of claim 13, wherein the list control element is a drop down box.

25. A system including a processor, a data warehouse, and an Internet connection capable of executing the steps comprising of:
receiving a username and a password from a web page;
identifying an account having the username and the password associated therewith;
reading a service level associated with the identified account;
determining at least one question that is authorized to be presented to the web page based on the service level associated with the account; and
populating a list control element of the web page with the at least one question.

26. The system of claim 25, wherein the account is identified by a security application.

27. The system of claim 25, wherein the security application searches a database for an account record having the username and the password associated therewith.

28. The system of claim 25, wherein the service level is read by a service application.

29. The system of claim 28, wherein the service application searches a database for an account record having the username associated therewith, and reads the service level from the account record.

30. The system of claim 25, wherein the at least one question is determined by a question and answer framework application.

31. The system of claim 30, wherein the question and answer framework application searches a database for the at least one questions based upon at least one of a plurality of appropriate service level indicators.

32. The system of claim 30, wherein the at least one of a plurality of appropriate service level indicators is the same as the service level.

33. The system of claim 30, wherein the at least one of a plurality of appropriate service level indicators is different from the service level.

34. The system of claim 25, wherein the at least one question includes at least one parameter.

35. The system of claim 25, wherein the processor is also configured to receive an indication that one of the at least one question has been selected, and populate a further list control element of the web page with an at least one parameter.

36. The system of claim 25, wherein the list control element is a drop down menu.

37. A method for specifying sales data to be accessed as a basis for a report, comprising the steps of:
(a) selecting one of an at least one question from a first list control element on a web page; and
(b) selecting at least one parameter from a second list control element on the web page, wherein the second list control element was created on the web page after the first selection of the one of the at least one question from the first list control element, and wherein the second list control element was populated with the at least one parameter after the first selection of the one of the at least one question from the first list control element.

38. The method of claim 37, further comprising: providing a username and password prior to the first selecting step.

39. The method of claim 38, wherein the at least one question is generated at least in part based on the username and password.

40. The method of claim 38, wherein the at least one parameter is generated at least in part based on the username and password.
